(19) United States
(12) Patent Application Publication
(10) Pub. No.: US 2023/0125653 A1
(43) Pub. Date: Apr. 27, 2023

(54) COMPOSITE ELECTRODE, METHOD FOR MANUFACTURING COMPOSITE ELECTRODE AND AN ALL-SOLID-STATE SECONDARY BATTERY INCLUDING THE COMPOSITE ELECTRODE

(71) Applicant: Electronics and Telecommunications Research Institute, Daejeon (KR)

(72) Inventors: Dong Ok SHIN, Daejeon (KR); Myeong Ju LEE, Daejeon (KR); Young-Gi LEE, Daejeon (KR); Seok Hun KANG, Daejeon (KR); Ju Young KIM, Daejeon (KR); Jimin OH, Daejeon (KR)

(73) Assignee: Electronics and Telecommunications Research Institute, Daejeon (KR)

(21) Appl. No.: 17/953,936

(22) Filed: Sep. 27, 2022

(30) Foreign Application Priority Data
Oct. 22, 2021 (KR) 10-2021-0142022
Jan. 6, 2022 (KR) 10-2022-0002268

(51) Int. Cl. H01M 10/056; H01M 10/0525; H01M 10/0585; H01M 4/62; H01M 4/04

(52) U.S. Cl. CPC H01M 10/056; H01M 10/0525; H01M 10/0585; H01M 4/623; H01M 4/0404; H01M 4/043; H01M 2300/0091; H01M 2004/021

(57) ABSTRACT

Disclosed is a composite electrode for an all-solid-state secondary battery. The composite electrode includes a composite positive electrode and a composite negative electrode, wherein each of the composite positive electrode and the composite negative electrode includes an electrode active material, and an ion-conducting composite binder configured to include an inorganic ion conductor for an ion movement path and an organic ion conductor for binding of the electrode active material.

### CROSS-REFERENCE TO RELATED APPLICATIONS

This application claims the benefit of the Korean Patent Application Nos. 10-2021-0142022 filed on Oct. 22, 2021 and 10-2022-0002268 filed on Jan. 6, 2022, which are hereby incorporated by reference as if fully set forth herein.

### BACKGROUND

### Field of the Invention

The present invention relates to technology regarding an electrode for an all-solid-state secondary battery.

### Discussion of the Related Art

There is demand for the development of a secondary battery with stability as well as characteristics required for general secondary batteries such as high performance, high capacity, and long lifespan. In particular, an all-solid-state secondary battery system that significantly lowers a risk by completely eliminating flammable liquid electrolyte has emerged.

All-solid-state secondary batteries have no risk of leakage, ignition, or explosion depending on external shocks or environments, and performance degradation due to low or high temperature operation is minimized. In addition, a solid electrolyte layer with excellent mechanical properties between positive and negative electrodes serves as an ion transport medium and also serves as a separator of polyolefin-based polymers used in liquid electrolyte-based secondary batteries to suppress internal short circuits due to impact. In addition, the all-solid-state secondary batteries may implement high voltage batteries by maximizing the use of internal space and allowing free battery external design, while maximizing energy density through bipolar electrode stacking.

Despite these advantages, the existing all-solid-state secondary batteries have the following problems.

A solid electrolyte in a composite electrode of an all-solid-state secondary battery of a related art generally has a zero-dimensional spherical shape, and requires 30 wt % or greater compared to an electrode configuration to form an active material/solid electrolyte ion transport interface and a solid electrolyte-solid electrolyte ion transfer path in the composite electrode. As a result, the content of an electrode active material in the composite electrode is relatively low, so that an electrode energy density per weight or volume is substantially reduced. In addition, a separate binder material should be included to form the electrode, and if electronic conductivity of the electrode active material is not sufficiently high, a conductive material should be additionally included.

### SUMMARY

An aspect of the present invention is directed to providing a composite electrode for an ion-conducting composite binder-based all-solid-state secondary battery for manufacturing a high-energy-density all-solid-state secondary battery.

The present invention complexes a zero-dimensional (particulate), one-dimensional (fibrous), two-dimensional (planar), 3-dimensional (cubic) high ion conductivity nano/micro-scale solid electrolyte as an inorganic ion conductor and an ion-conducting polymer binder having cohesion/adhesion properties as an organic ion conductor together to be applied as an ion-conducting composite binder material serving as both an electrolyte and a binder in a composite electrode. This is because an inorganic ion conductor alone is required by a large amount in the composite electrode and forms a hard solid/solid interface with an electrode active material to cause high interfacial resistance. Only the ion-conducting binder, as an organic ion conductor in the composite electrode, has significantly low ion conductivity, making it difficult to quickly transfer ions. Therefore, in order to overcome the shortcomings of these individual materials, the inorganic ion conductor and the organic ion conductor may be complexed to serve as an electrolyte and a binder in the composite electrode to relatively increase the content of an active material in the electrode to maximize an energy density ultimately.

To achieve these and other advantages and in accordance with the purpose of the invention, as embodied and broadly described herein, there is provided a composite electrode for an all-solid-state secondary battery, including a composite positive electrode and a composite negative electrode, wherein each of the composite positive electrode and the composite negative electrode includes an electrode active material; and an ion-conducting composite binder configured to include an inorganic ion conductor for an ion movement path and an organic ion conductor for adhesion of the electrode active material.

In another aspect of the present invention, there is provided a method for manufacturing a composite electrode for an all-solid-state secondary battery, including: putting a high ion conductive solid electrolyte as an inorganic ion conductor into a polymer binder solution in which lithium salt constituting an organic ion conductor is dissociated, and then preparing a composite binder solution through a ball-milling process; mixing and stirring an electrode active material and the composite binder solution through a mechanical mixing process to prepare an electrode slurry; applying the electrode slurry on a current collector and drying the electrode slurry applied to the current collector through a drying process; and compressing the dried electrode slurry applied on the current collector through a compression process.

In another aspect of the present invention, there is provided an all-solid-state secondary battery including: a solid electrolyte membrane; and a composite electrode including a composite positive electrode and a composite negative electrode formed with the solid electrolyte membrane interposed therebetween, wherein each of the composite positive electrode and the composite negative electrode includes an electrode active material; and an ion-conducting composite binder configured to include an inorganic ion conductor for an ion movement path and an organic ion conductor for adhesion of the electrode active material.

The present invention designs and proposes a composite electrode for an all-solid-state secondary battery with a smaller content by applying an ion conductivity organic/inorganic composite binder capable of serving as an electrolyte and a binder in a composite electrode to solve the problem of a solid electrolyte-based composite electrode having a zero-dimensional structure that requires a large content in an all-solid-state secondary battery electrode of the related art.

In order to achieve the above object, the present invention provides a high ion conductive solid electrolyte technology with a controlled size and shape. It is positioned between spherical active materials in a composite electrode and a size and shape thereof are controlled to be complexed with a binder.

The present invention provides an ion-conducting binder technology having cohesion/adhesion properties. A polymer acting as a binder dissociates lithium salt and enables movement in a polymer matrix to have lithium ion conductivity, and has cohesion/adhesion properties by itself to be applied as a binder.

The present invention provides a technology for selecting a solid electrolyte as an inorganic ion conductor and an ion-conducting binder as an organic ion conductor and complexing the same. A composite binder with high ion conductivity is manufactured by optimizing the content ratio of inorganic and organic conductors in the ion-conducting composite binder and a mixing process.

Finally, a composite electrode is manufactured on a current collector through a slurry-based electrode coating manufacturing process using an ion-conducting composite binder and an electrode active material. The ion-conducting binder surrounds the electrode active material to form an electrode, and a solid electrolyte is positioned along the binder. The solid electrolyte lowers crystallinity of the ion-conducting binder and forms an interface with high ion conductivity to improve ion conductivity of the composite binder. The composite binder forms a close interface with the electrode active material to lower internal resistance of the electrode and maintain the composite electrode structure through cohesion/adhesion properties. By applying the ion-conducting composite binder, a lithium ion transfer path may be formed in the composite electrode with a minimized electrolyte content, thereby manufacturing a composite electrode with high energy density.

According to the present invention, in the ion-conducting composite binder material, an ion-conducting polymer binder, which is an organic ion conductor, and a high ion conductive solid electrolyte, which is an inorganic ion conductor, are complexed to form a close interface with the electrode active material, while maintaining high ion conductivity, thereby minimizing interface resistance and configure an electrode through the cohesion/adhesion properties. Accordingly, when configuring a composite electrode for an all-solid-state secondary battery, an ion transfer path may be configured with a relatively small content, compared to a zero-dimensional solid electrolyte, thereby substantially increasing an implementation capacity of the battery.

In addition, the all-solid-state secondary battery to which the ion-conducting composite binder-based composite electrode is applied has no risk of explosion or ignition and has excellent mechanical strength, making it possible to manufacture a battery with a high energy density, while securing high safety by utilizing lithium metal having high theoretical capacity as an electrode.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1A is a schematic view illustrating a structure of a composite electrode according to the related art.

FIG. 1B is a schematic view illustrating a structure of a composite electrode for an ion-conducting composite binder-based all-solid-state secondary battery according to an embodiment of the present invention.

FIG. 2A is a graph showing impedance results for analysis of ion conductivity of a composite electrode (Comparative Example 1, graphite) manufactured based on an inactive binder.

FIG. 2B is a graph showing impedance results for analysis of ion conductivity of a composite electrode manufactured based on a composite binder (Embodiment, graphite) according to an embodiment of the present invention.

FIG. 3 is a graph of specific capacity according to charge/discharge rates of composite electrodes based on an inactive binder (Comparative Example 1), an ion-conducting binder (Comparative Example 2), and a composite binder (Embodiment).

FIG. 4 is a table summarizing the specific discharge capacity for each of Comparative Example 1, Comparative Example 2, and Embodiment according to a charge/discharge rate.

### DETAILED DESCRIPTION OF THE INVENTION

Hereinafter, embodiments of the present invention will be described in detail with reference to the accompanying drawings. In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

An all-solid-state secondary battery according to the present invention is a system in which a liquid electrolyte in an electrode is completely excluded, includes a composite positive electrode, a solid electrolyte membrane, and a composite negative electrode, and here, a lithium metal may be used instead of the composite negative electrode.

The composite positive electrode includes an electrode active material, an ion-conducting composite binder, and a conductive material, and the composite negative electrode includes an electrode active material and an ion-conducting composite binder. The ion-conducting composite binder is an electrolyte component having ion-conducting properties, and is a material in which an inorganic ion conductor and an organic ion conductor are complexed.

A high ion conductive solid electrolyte, as an inorganic ion conductor, may be configured to include zero-dimensional (spherical), one-dimensional (fibrous), and two-dimensional (planar) particles. In the case of a zero-dimensional spherical solid electrolyte, a diameter may be determined between 0 and 1 m. A one-dimensional linear solid electrolyte may have a diameter determined between 0 and 1 m and an aspect ratio (length/diameter) determined between 20 and 1000. The two-dimensional planar solid electrolyte may have an area determined between 0 to 10 um² and a thickness determined between 0 to 1 um.

A high ion conductive solid electrolyte, as an inorganic ion conductor, may be an oxide-based solid electrolyte having a garnet-type crystal structure, and a chemical formula of the oxide-based solid electrolyte may be Li_{7-3x+y-z}AₓLa_{3-y}B_{y}Zr_{2-z}C_{z}O₁₂. Here, A may be Al or Ga, B may be Ca, Sr, or Ba, and C may be Ta, Nb, Sb or Bi. In particular, for Li₇₋ₓAₓLa₃Zr₂O₁₂, Al, Ga, etc. may be doped as doping elements at a site of Li in a ratio of 0 to 0.3 mol, and Nb, Ta, etc., may be doped as doping elements at a site of Zr in a ratio of 0 to 0.3 mol. Li₃ₓLa_{(2/3)-x}□_{(1/3)-2x}TiO₃ (LLTO, 0<x<0.16, □: vacancy) may be selected as a material having a perovskite structure.

A high ion conductive solid electrolyte, as an inorganic ion conductor, may be a phosphate-based solid electrolyte having a NAISICON structure, and a chemical formula of the phosphate-based solid electrolyte may be Li₁₊ₓAlₓTi₂₋ₓ(PO₄)₃. Here, x=0 to 0.4.

A high ionic conductive solid electrolyte, as an inorganic ion conductor, may be a sulfide-based solid electrolyte. Sulfide-based solid electrolytes may be selected from the group of compounds including a chalcogenide element and lithium, such as materials such as Li₁₀SnP₂S₁₂, Li₄₋ₓSn₁₋ₓAsₓS₄ (x=0˜100) from the group of Li_{10±1}MP₂X₁₂ (M=Ge, Si, Sn, Al or P and X=S or Se), materials such as Li_{3.25}Ge_{0.25}P_{0.75}S₄, Li₁₀GeP₂S₁₂ from the group of thio-lithium superionic conductor(thio-LISICON), materials such as Li₆PS₅Cl from the group of Li-argyrodite Li₆PS₅X (X=Cl, Br or I), materials such as Li₂SP₂S₅ (xLi₂S(100−x)P₂S₅, x=0˜100) having a glass-ceramic structure, and materials such as Li₂P₂S₅, Li₂SSiS₂Li₃N, Li₂SP₂S₅LiI, Li₂SSiS₂LiₓMO_{y}, Li₂SGeS₂, Li₂SB₂S₃LiI from the group having a glassy structure.

An ion-conducting binder, as an organic ion conductor, is a polymer material that dissociates lithium salt to retain ion conducting properties by itself, while at the same time having a binder characteristic with cohesion/adhesion between all components in the composite electrode and with a current collector. The organic ion conductor is complexed with the inorganic ion conductor to form an ion-conducting composite binder and form a close interface with a solid electrolyte layer by soft properties thereof.

Examples of the ion-conducting binder material may include lithium or lithium salt-containing polytetrafluoroethylene, polyvinylidene fluoride, polyvinylidene fluoride-hexafluoropropylene, polyethylene oxide, polyacrylonitrile, polyacrylic acid, styrene-butadiene, nitrile-butadiene rubber, butadiene rubber, etc. The lithium-substituted cellulose derivative and the polymer binder material containing lithium or lithium salt may be used alone or in combination.

The lithium salt may include one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI, LiPDI, and combinations thereof, and after application of an electrode slurry, bonding between the electrode materials is adhered to a metal foil (current collector) and maintained.

An electrode active material for manufacturing a composite positive electrode may include lithium cobalt oxide (LiCoO₂), lithium nickel oxide (LiNiO₂), lithium manganese oxide (LiMnO₄), lithium nickel cobalt aluminum oxide (LiNiCoAlO₂), olivine (LiFePO₄), lithium cobalt manganese nickel oxide (LiCoₓMn_{y}Ni_{z}O₂; x+y+z=1), a mixture thereof, or a solid solution thereof.

An electrode active material for manufacturing a composite positive electrode graphite, hard carbon, soft carbon, carbon nanotube, graphene, redox graphene, carbon fiber, amorphous carbon, silicon-carbon composite (SiC), high-capacity negative electrode material coated with an electronic conductive layer such as carbon [silicon or silicon oxide (SiOₓ), tin (Si), cobalt oxide (CoOₓ), iron oxide (FeOₓ)], etc. and a mixture thereof, as a material which is advantageous for mechanical deformation and has high electron conductivity (2 S/cm or more).

Conductive materials may be a material that is basically conductive and light and may include at least one of, for example, graphite, hard/soft carbon, carbon fiber, carbon nanotube, linear carbon, carbon black, acetylene black, and Ketjen black.

Based on a total weight of the composite electrode (composite positive electrode or composite negative electrode), the content of the ion-conducting composite binder is 3 to 15 wt % (weight percentage), preferably, 3 to 10 wt %. Also, based on a total weight of the ion-conducting composite binder, the content of the inorganic ion conductor is 5 to 50 wt %, preferably 20 to 30 wt %.

The present applicant found through a number of experiments that, when a minimum content of the ion-conducting composite binder is less than 3 wt %, the electrode active material is peeled off from the current collector in the application process of applying the electrode active material to the current collector, such as a metal foil. Through these experiments, the present applicant found that a minimum content of the ion-conducting composite binder capable of providing sufficient adhesion that the electrode active material does not peel off from the current collector is 3 wt %.

In the present invention, by configuring a maximum content of the ion-conducting composite binder to be 15 wt %, the content of the electrode active material in the composite electrode (composite positive electrode or composite negative electrode) may be maximized. In an electrode of a general all-solid-state battery, the content of a binder is approximately 2 wt % and the content of a solid electrolyte is 20 to 30 wt %, so the content of the electrode active material may be 67 to 88 wt %. In contrast, the ion-conducting composite binder according to the present invention is configured to include an organic ion conductor serving as a binder and an inorganic ion conductor serving as a solid electrolyte to simultaneously perform the role of the solid electrolyte and the role of a general binder, the maximum content of the ion-conducting composite binder may be set to 15 wt %, thereby increasing the content of the electrode active material to 85 to 97 wt %.

As such, according to the content (3 to 15 wt %) of the ion-conducting composite binder according to the present invention, the content of the electrode active material included in the electrode of the all-solid-state battery may be maximized, thereby maximizing an energy density.

When configuring the composite positive electrode, the content of a conductive material is between 1 and 5 wt %, preferably between 1 and 2 wt %. When the conductivity of the positive electrode active material in the composite positive electrode is ˜10 S/cm@25° C. or more, the conductive material may be excluded. The content of the active material of the composite electrode is determined as a portion excluding the composite binder (inorganic ion conductor+organic ion conductor) and the conductive material (in the case of a positive electrode).

The composite electrode is manufactured through a slurry-based thick film coating process.

Specifically, first, a high ion conductive solid electrolyte as an inorganic ion conductor is put into a polymer binder solution in which lithium salt constituting an organic ion conductor is dissociated according to a certain composition ratio, and then mixed through a ball-milling mixing process to prepare a binder solution.

Next, an electrode slurry is prepared by mixing and stirring an electrode active material with the composite binder solution through a mechanical mixing process. In this case, in the case of a composite positive electrode, a conductive material may be further mixed in addition to the electrode active material and the composite binder solution.

Next, after applying (coating) the electrode slurry on a current collector (e.g., metal foil, etc.), the electrode slurry applied on the current collector is dried through a drying process.

Next, a composite electrode (composite positive electrode and composite negative electrode) is prepared by compressing the dried electrode slurry applied on the current collector through a pressing process. In this case, a loading level indicating a weight of the electrode active material per unit area may be determined by controlling viscosity of the slurry and a thickness during application. In addition, in the compression process, a process of compressing the dried electrode slurry at a pressure of 100 to 400 mPa may be performed so that the composite electrode has a porosity of 5 to 15% (preferably 5 to 8%). A thickness of the composite electrode is 1 to 300 um, and an energy density may increase as the thickness increases, and it is desirable to maximize the content of an active material by minimizing components unrelated to the energy density.

Hereinafter, embodiments of the present invention will be described in more detail with reference to the accompanying drawings.

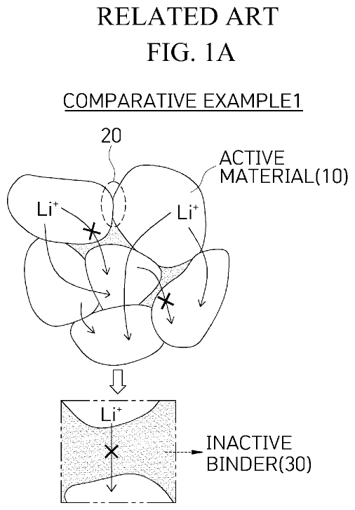

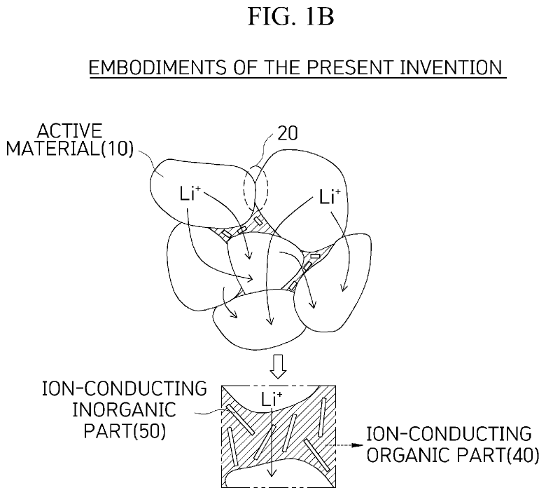

FIG. 1A is a schematic view illustrating a structure of a composite electrode of the related art, and FIG. 1B is a schematic view illustrating a structure of a composite electrode for an ion-conducting composite binder-based all-solid-state secondary battery according to an embodiment of the present invention.

A composite electrode for an all-solid-state secondary battery illustrated in FIG. 1A includes an electrode active material 10 and an inactive binder 30, and a composite electrode for an all-solid-state secondary battery according to an embodiment of the present invention illustrated in FIG. 1B includes the electrode active material 10, a composite binder. Here, the composite binder according to an embodiment of the present invention includes ion-conducting organic part 40 and ion-conducting inorganic part 50. In this document, the ion-conducting organic part 40 may be referred to as an organic ion conductor and the ion-conducting inorganic part 50 may be referred to as an inorganic ion conductor.

In the composite electrode of the related art shown in FIG. 1A, the inactive binder 30 has no ion conductivity, and thus, ions (e.g., Li+) move using only a contact portion 20 of the electrode active material 10 as a movement path.

In contrast, in the composite electrode according to an embodiment of the present invention shown in FIG. 1B, since the composite binder has ion conductivity, ions (e.g., Li+) may move more quickly in the composite electrode using the composite binder, as well as the contact portion 20 of the electrode active material 10, as a movement path. Therefore, the composite electrode according to the embodiment of the present invention may have better electrode performance than the composite electrode of the related art.

In the composite electrode based on the composite binder, electrolyte components (components contributing to ion conduction in the electrode) may be minimized, compared to the composite electrode of the related art containing a solid electrolyte, thereby ultimately maximizing the energy density of the electrode.

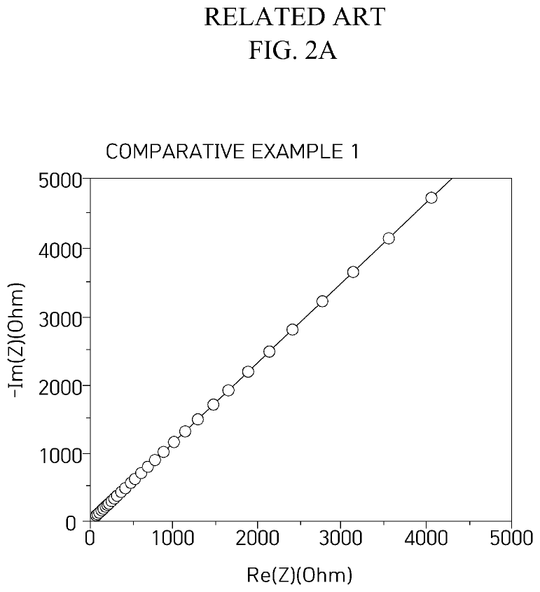

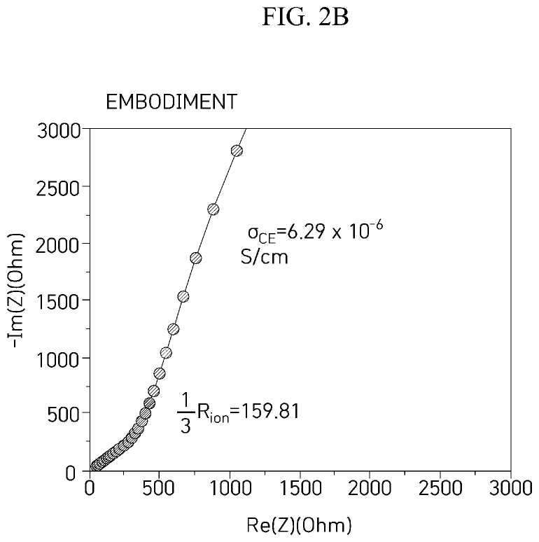

FIG. 2A is a graph showing impedance results for analysis of ion conductivity of a composite electrode (Comparative Example 1, graphite) manufactured based on an inactive binder and FIG. 2B is a graph showing impedance results for analysis of ion conductivity of a composite electrode manufactured based on a composite binder (Embodiment, graphite) according to an embodiment of the present invention.

Referring to FIG. 2A, it can be seen that, in the case of a composite electrode prepared based on an inactive binder of Comparative Example 1, since there is no ion transfer path in the composite electrode, an ion conductive component does not appear in an impedance curve, as shown in FIG. 2A.

In contrast, it can be seen that the composite electrode manufactured based on the composite binder according to an embodiment of the present invention illustrated in FIG. 2B exhibits composite electrode ion conductivity of 6.29×10⁻⁶ S/cm.

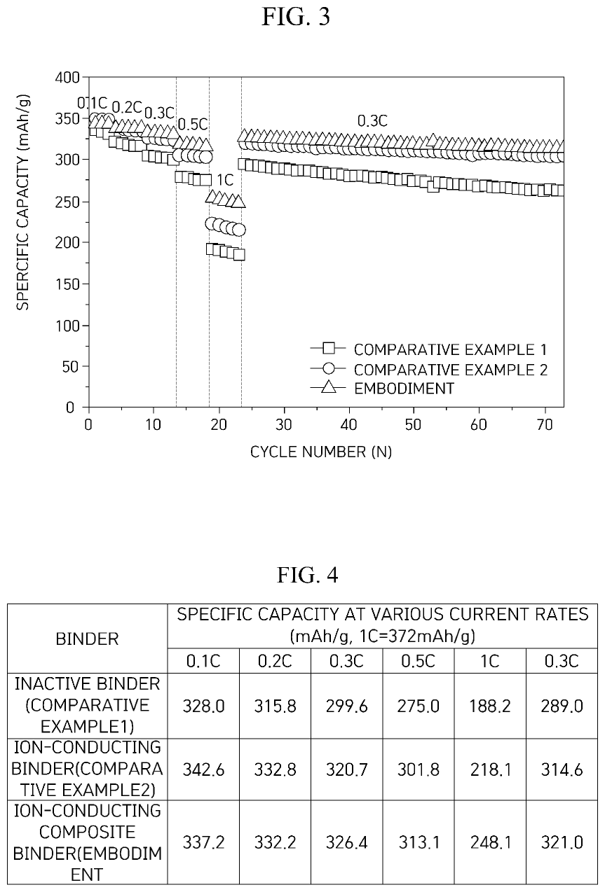

FIG. 3 is a graph of specific capacity according to charge/discharge rates of composite electrodes based on an inactive binder (Comparative Example 1), an ion-conducting binder (Comparative Example 2), and a composite binder (Embodiment).

Referring to FIG. 3, at a low charge/discharge rate, since the insertion (charge) and desorption (discharge) of ions into the electrode active material in the composite electrode occur at a slow rate, only the contact portion of the electrode active material is sufficient, so there is no significant difference in specific capacity. However, it can be seen that, as the charge/discharge rate increases, implementation of the specific capacity shows a difference and the composite binder-based composite negative electrode exhibits the highest specific capacity.

FIG. 4 is a table summarizing the specific discharge capacity for each of Comparative Example 1, Comparative Example 2, and Embodiment according to a charge/discharge rate.

### EMBODIMENT

In this Embodiment, a composite negative electrode is manufactured with an ion-conducting composite binder-based composite electrode through a slurry-based coating process. The composite negative electrode includes natural graphite/composite binder and is manufactured in a 95:5 weight ratio.

First, an organic ion conductor constituting the composite binder was prepared by dissolving an ion-conducting binder with polyethylene oxide and lithium salt LiClO₄ with acetonitrile (CAN).

Next, as an inorganic ion conductor, a one-dimensional oxide-based solid electrolyte was prepared by electrospinning Li₇La₃Zr₂O₁₂ (LLZO). polyvinylpyrrolidone (PVP) was dissolved in ethanol at 15 wt % to prepare a polymer solution.

Next, LiNO₃, La(NO₃)₃.6H₂O, ZrOCl₂.8H₂O raw materials were dissolved in a solution of ethanol:water (80:20, weight ratio) at 1 m mole concentration according to a stoichiometry ratio. At this time, Al(NO₃)₃.9H₂O was dissolved together at a ratio of 1.2 wt %. The polymer solution and the solid electrolyte component solution were mixed and stirred in a volume ratio of 6:4 to prepare a precursor solution.

1 mL of the precursor solution was into a syringe, to which a constant pressure was applied to let it flow through a nozzle at a rate of 0.03 ml/min. At this time, a voltage of 18 kV was applied between the nozzle and the collector so that nanofibers are generated from the nozzle.

The prepared polymer/solid electrolyte nanofibers were recovered from the collector and heat-treated at 700° C. for 3 hours to prepare a one-dimensional LLZO solid electrolyte. The prepared one-dimensional LLZO solid electrolyte at an appropriate amount of 27 wt %, compared to polyethylene oxide, was added to the ion-conducting binder solution, and then mixed at 1500 to 2000 rpm for 30 to 60 minutes through a ball milling mixing process.

Next, the natural graphite/composite binder was quantified according to a weight ratio of 95:5, and mixed in a stirrer at 1500 to 2000 rpm for 10 to 30 minutes to prepare an electrode slurry. If necessary, the stirring process may be repeated 2 to 3 times.

The slurry was coated on nickel foil by adjusting a thickness by a doctor blade method, and dried in a vacuum oven at 90 to 100° C. for 10 to 15 hours. A loading level of the prepared composite negative electrode was adjusted to 2 to 20 mg/cm² depending on a coating thickness.

### Comparative Example 1

Comparative Example 1 was manufactured in the same manner, except that a binder prepared by dissolving polyethylene oxide in acetonitrile, rather than the composite binder in Embodiment, was used and an electrode (graphite/binder, 95:5, weight ratio) excluding one-dimensional LLZO solid electrolyte was manufactured.

### Comparative Example 2

Comparative Example 2 was manufactured in the same manner, except that an ion-conducting binder prepared by dissolving polyethylene oxide and LiClO₄ in acetonitrile, rather than the composite binder in Embodiment, was used and an electrode (graphite/binder, 95:5, weight ratio) excluding one-dimensional LLZO solid electrolyte was manufactured.

In order to measure ion conductivity in the composite negative electrode, a cell was configured with nickel/composite negative electrode/solid electrolyte layer/composite negative electrode/nickel and impedance was analyzed. Li₆PS₅Cl (LPSCl) was used as a solid electrolyte layer.

First, the solid electrolyte layer with a diameter of 13 mm was formed by cold sintering at a pressure of 200 to 400 MPa and a composite negative electrode and a lithium metal electrode were formed on both sides of the solid electrolyte layer, and then a pressure of 100 to 200 MPa was applied to form a close interface between the solid electrolyte layer and the composite negative electrode to prepare a resistance measurement cell.

Measurement was performed by applying AC impedance in the range of 10⁻¹ to 10⁵ Hz using a frequency response analyzer (Solartron HF 1225). Through a transmission line mode (TLM) application, a resistance value was obtained from an impedance curve, and an ion conductivity value was obtained from a formula of thickness/(resistance x area) in units of S/cm.

In order to analyze battery characteristics of the composite negative electrode, a half-cell including a composite negative electrode/solid electrolyte layer/lithium metal was prepared. LPSCl was used as the solid electrolyte layer between the composite negative electrode and the lithium metal electrode.

First, a solid electrolyte layer with a diameter of 13 mm was formed by cold sintering at a pressure of 200 to 400 MPa and a composite negative electrode and a lithium metal electrode were formed on both sides of the solid electrolyte layer, and then, a pressure of 100 to 200 MPa was applied to form a close interface between the solid electrolyte layer and the composite negative electrode to manufacture an all-solid-state battery. To analyze charge/discharge characteristics, charging was performed in a CC-CV mode and discharging was performed in a CC mode, and a cut-off voltage was set to 0.01 to 2V. Charging and discharging were performed at 60 degrees at a charge/discharge rate of 0.1C to 1C.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A composite electrode for an all-solid-state secondary battery comprising:
a composite positive electrode and a composite negative electrode,
wherein each of the composite positive electrode and the composite negative electrode includes:
an electrode active material; and
an ion-conducting composite binder configured to include an inorganic ion conductor for an ion movement path and an organic ion conductor for binding of the electrode active material.

2. The composite electrode of claim 1, wherein a content of the inorganic ion conductor is 5 to 50 wt % based on a total weight of the ion-conducting composite binder.

3. The composite electrode of claim 1, wherein the inorganic ion conductor is a high-ionic solid electrolyte including spherical (zero-dimensional) particles having a diameter greater than 0 and less than 1 m.

4. The composite electrode of claim 1, wherein the inorganic ion conductor is a high ionic solid electrolyte including fibrous (one-dimensional) particles having a diameter greater than 0 and less than 1 m and an aspect ratio of 20 to 1000.

5. The composite electrode of claim 1, wherein the inorganic ion conductor is a high-ionic solid electrolyte including flat (two-dimensional) particles having an area greater than 0 and less than 10 um² and a thickness greater than 0 and less than 1 um.

6. The composite electrode of claim 1, wherein a content of the ion-conducting composite binder is 3 to 15 wt % based on a total weight of the composite positive electrode or the composite negative electrode.

7. The composite electrode of claim 1, wherein the composite positive electrode further includes a conductive material and is 1 to 5 wt % based on a total weight of the composite positive electrode.

8. The composite electrode of claim 1, wherein the inorganic ion conductor is any one selected from an oxide-based solid electrolyte, a phosphate-based solid electrolyte, and a sulfide-based solid electrolyte.

9. The composite electrode of claim 1, wherein the organic ion conductor is a polymer binder material including lithium or lithium salt.

10. A method for manufacturing a composite electrode for an all-solid-state secondary battery, the method comprising:
putting a high ion conductive solid electrolyte as an inorganic ion conductor into a polymer binder solution in which lithium salt constituting an organic ion conductor is dissociated, and then preparing a composite binder solution through a ball-milling process;
mixing and stirring an electrode active material and the composite binder solution through a mechanical mixing process to prepare an electrode slurry;
applying the electrode slurry on a current collector and drying the electrode slurry applied to the current collector through a drying process; and
compressing the dried electrode slurry applied on the current collector through a compression process.

11. The method of claim 10, wherein the high ion conductive solid electrolyte is any one selected from an oxide-based solid electrolyte, a phosphate-based solid electrolyte, and a sulfide-based solid electrolyte.

12. The method of claim 10, wherein the compressing includes compressing the dried electrode slurry at a pressure of 100 to 400 mPa so that the composite electrode has a porosity of 5 to 15%.

13. An all-solid-state secondary battery comprising:
a solid electrolyte membrane; and
a composite electrode including a composite positive electrode and a composite negative electrode formed with the solid electrolyte membrane interposed therebetween,
wherein each of the composite positive electrode and the composite negative electrode includes:
an electrode active material; and
an ion-conducting composite binder configured to include an inorganic ion conductor for an ion movement path and an organic ion conductor for binding of the electrode active material.

14. The all-solid-state secondary battery of claim 13, wherein the composite positive electrode is configured to further include a conductive material when conductivity of the electrode active material in the composite positive electrode is less than 10 S/cm@25° C.

15. The all-solid-state secondary battery of claim 13, wherein the inorganic ion conductor, is an oxide-based solid electrolyte having a garnet-type crystal structure, a phosphate-based solid electrolyte having a NAISICON structure, or a sulfide-based solid electrolyte.

16. The all-solid-state secondary battery of claim 13, wherein the organic ion conductor includes one selected from the group consisting of polytetrafluoroethylene, polyvinylidene fluoride, polyvinylidene fluoride-hexafluoropropylene, polyethylene oxide, polyacrylonitrile, polyacrylic acid, styrene-butadiene, nitrile-butadiene rubber, butadiene rubber, and combinations thereof.
